(19) United States
(12) Patent Application Publication
(10) Pub. No.: US 2016/0195487 A1
(43) Pub. Date: Jul. 7, 2016

(54) Method for determining the quality of reducing agent

(71) Applicant: EMITEC GESELLSCHAFT FUR EMISSIONSTECHNOLOGIE MBH, Lohmar (DE)

(72) Inventors: Jan HODGSON, Troisdorf (DE); STEVN SCHEPERS, Troisdorf (DE); Andree BERGMANN, Elsenach (DE); Morten-Peter MOELLER, Brabrand (DK)

(21) Appl. No.: 14/910,571

(22) PCT Filed: Jul. 31, 2014
(86) PCT No.: PCT/EP2014/066500

§ 371 Date: Feb. 5, 2016

(30) Foreign Application Priority Data
Aug. 7, 2013 (DE) 10 2013 108 505.9

(51) Int. Cl. G01N 27/06; G01N 25/00; F01N 13/00; F01N 3/20; F01N 11/00

(52) U.S. Cl. CPC G01N 27/06; F01N 3/206; F01N 11/00; F01N 13/008; G01N 25/00; F01N 2550/05

(57) ABSTRACT

In a method for determining a quality of reducing agent, a pretreatment of the reducing agent is firstly performed. The temperature of the pretreated reducing agent is subsequently determined. The electrical conductivity of the pretreated reducing agent is then determined, and subsequently, the quality of the reducing agent is calculated with the aid of the electrical conductivity and the temperature.

### CROSS-REFERENCE TO RELATED APPLICATIONS

This is a U.S. national stage of application No. PCT/EP2014/066500, filed on 31 Jul. 2014, which claims priority to the German Application No. 10 2013 108 505.9 filed 7 Aug. 2013, the content of both incorporated herein by reference.

### BACKGROUND OF THE INVENTION

1. Field of the Invention

The invention relates to a method for determining the quality of (liquid) reducing agent, in particular of a urea-water solution, and to a dosing device for the dosing of reducing agent that is stored in a tank, by which device the method can be carried out. The method and the dosing device are suitable in particular for a mobile application in the automotive sector.

2. Related Art

In particular for mobile internal combustion engines in motor vehicles, exhaust gas purification devices are known into which a reducing agent is fed for the chemical reduction of certain exhaust-gas constituents. It is, for example, possible for nitrogen oxide compounds (NOx) in the exhaust gas to be eliminated in a particularly effective manner if ammonia is supplied as reducing agent to the exhaust gas. Typical reducing agents such as, for example, ammonia are hazardous substances and are therefore not normally stored in motor vehicles directly. Instead, reducing agent is often stored in the form of a reducing agent precursor in a separate tank as an additional operating fluid in the motor vehicle. A typical reducing agent precursor is, for example, urea. This is stored in the motor vehicle, for example in the form of a 32.5% urea-water solution. A urea-water solution of this type is available, for example, under the trade name “AdBlue®”. Merely for the sake of completeness, it is pointed out at this juncture that, below, the expression “reducing agent” should also be understood to include reducing agent precursors and their solutions (such as in particular aqueous urea).

The consumption of reducing agent is low in relation to the fuel consumption of an internal combustion engine. The consumption of reducing agent is typically approximately 0.5% to 10% of the fuel consumption of an internal combustion engine of a motor vehicle. The amount of reducing agent to be introduced into the exhaust gas is dependent, inter alia, on the quality of the reducing agent. The quality of the reducing agent refers substantially to a concentration of urea in the reducing agent. This is to be attributed in particular to the fact that the ammonia required for the catalytically assisted reaction is generated from the urea, and this is possible in a particularly reliable manner, and without residues, only if the concentration of the urea in the reducing agent lies within predefined limits.

If reducing agent is added, for replenishment purposes, into a tank provided for the purpose in the motor vehicle, the quality of the reducing agent added for replenishment purposes may differ from the quality of the reducing agent situated in the tank. Furthermore, the quality of the reducing agent in the tank may vary over time. In particular, aging of the reducing agent may occur, with the urea in the reducing agent breaking down to form, inter alia, ammonia. Impurities also have an influence on the quality of the reducing agent.

In the past, various approaches have been taken for determining the quality of the reducing agent. For example, it has been attempted to determine the quality of the reducing agent with the aid of ultrasound propagation time measurements.

### SUMMARY OF THE INVENTION

Taking this as a starting point, it is an object of the present invention to at least partially solve the technical problems highlighted in connection with the prior art. It is sought in particular to specify a particularly advantageous method for determining the quality of reducing agent, and a dosing device by which the method can be carried out.

It should be noted that the features listed individually can be combined with one another in any desired technologically expedient manner, thus highlighting further embodiments of the invention. The description, in particular in conjunction with the figures, specifies further particularly preferred embodiments.

For this purpose, there is proposed a method for determining a quality of reducing agent, comprising at least the following steps:

i) performing a pretreatment of the reducing agent;

ii) determining a temperature of the pretreated reducing agent;

iii) determining an electrical conductivity of the pretreated reducing agent; and iv) calculating the quality of the reducing agent with the aid of the electrical conductivity and the temperature.

The method is provided in particular for determining a quality of reducing agent in a mobile application in the automotive sector.

Here, the expression “quality” refers substantially to a concentration of a component in the reducing agent. In particular, this means also that the quality of the reducing agent corresponds to a concentration of a component in the reducing agent. In this case, in general, a very high (maximum) quality corresponds to a situation in which the concentration of a component is at a certain comparative value. A deviation from the comparative value signifies a reduced quality. In particular, the quality corresponds to a concentration of urea in a urea-water solution. It is preferably the case here that a comparative value of 32.5% urea in the urea-water solution corresponds to a very high (maximum) quality, whereas an upward or downward deviation corresponds to a reduced quality. The expression “quality” preferably additionally encompasses an item of information regarding an ammonia content in the reducing agent. In particular in the case of urea-water solution as a reducing agent, ammonia is formed as a result of aging of the reducing agent. In the process, urea in the reducing agent is dissipated and converted into ammonia. An increased ammonia content reduces the quality of the reducing agent.

The information obtained by the method regarding the quality of the reducing agent may in particular be utilized to determine exactly what amount of reducing agent must be introduced into the exhaust line in order to effect a complete reduction of the exhaust-gas constituents, wherein, in particular, it is also ensured that no more reducing agent is provided than is required for the complete reduction. In particular, the demand for reducing agent can be determined on the basis of operating parameters of the internal combustion engine, which enable conclusions to be drawn regarding the exhaust-gas composition. It is also possible for the composition of the exhaust gas or the loading of a catalytic converter substrate body to be directly measured with the aid of exhaust-gas sensors in order to determine the demand for reducing agent, wherein the information regarding the quality can be used to exactly meet this demand.

As already explained further above, the quality of a reducing agent is substantially an item of information regarding a concentration of urea in the reducing agent. Accordingly, in particular, less reducing agent needs to be introduced into the exhaust line in the presence of a relatively high concentration of urea in the reducing agent than in the presence of low urea concentrations.

In the described method, the quality of the reducing agent is calculated in step iv), wherein an electrical conductivity of the reducing agent measured in step iii) is used as a variable for the calculation of the quality. It has also been found that the information regarding the quality of the reducing agent can be calculated from the electrical conductivity if the temperature of the reducing agent is taken into consideration as a cross influence. The temperature of the reducing agent is thus determined (in particular measured) in step ii) and taken into consideration (as a cross influence) in the calculation in step iv).

Consideration is given in particular to the quality of pretreated reducing agent, which means in particular that consideration is given to the quality of reducing agent that is to be delivered (immediately thereafter) into the exhaust line, in contrast to reducing agent that remains stored in a tank. As a result of the pretreatment of the reducing agent, it is possible for further cross influences on the quality (aside from the temperature) to be at least partially reduced, suppressed or eliminated. In step iv), it is thus possible to forgo the consideration of further cross influences. The pretreatment of the reducing agent before the measurement of the temperature and of the conductivity thus permits a considerable simplification of the determination of the quality. In particular, by the pretreatment of the reducing agent, it is also possible to eliminate transverse influences of unknown influential variables on the conductivity measurement and/or on the quality of the reducing agent. Treated reducing agent is to be understood in particular to mean filtered, purified and/or heated reducing agent. The integration of a pretreatment of the reducing agent into the method is made possible in particular by virtue of the fact that, by the described method, the quality of the reducing agent is determined not in a tank for storing reducing agent but within a delivery unit or dosing unit for the provision of the reducing agent. This permits a situation in particular in which in each case only a limited amount of reducing agent (which is small in relation to the tank volume) needs to be pretreated. Suitable measures for the pretreatment of reducing agent will be explained in more detail below.

It is furthermore preferable if the electrical conductivity of the reducing agent in step iii) is measured by a sensor with a first electrical contact and a second electrical contact which are electrically connected to the reducing agent.

It is pointed out that, in the context of the determination of the electrical conductivity, it is always possible here for consideration to be given to dielectric variables, individually or in combination with one another, which under the given conditions may exhibit defined interdependence with the electrical conductivity (in particular conductance, voltage, current strength, resistance etc.).

During the measurement of the conductivity, the first electrical contact and the second electrical contact are completely surrounded by reducing agent, such that an electrical resistance of the reducing agent between the first electrical contact and the second electrical contact can be determined.

It is preferably the case that, within the line, a space between the first electrical contact and the second electrical contact is completely filled with reducing agent. The conductance of the reducing agent is determined from the reciprocal of the electrical resistance thus determined.

It is considered to be advantageous if, in step iii), a voltage is applied in each case between the first electrical contact and the second electrical contact and between the first electrical contact and a third electrical contact, wherein electrical resistances at least between the first electrical contact and the second electrical contact and between the first electrical contact and the third electrical contact are determined and, in step c), a conductance is determined from the two determined electrical resistances. In this way, it is possible in particular for an averaged conductance to be determined on the basis of the determined resistances. If one of the electrical contacts is formed from a different material, the measurement values vary, such that a respective electrical conductivity of the reducing agent should be determined first, with an average value only then being determined if necessary. It is thus possible for the actual conductivity to be determined with greater accuracy. It is also possible for a measurement of the difference between the two determined resistances to be carried out in order to determine the conductance in a particularly accurate manner. In particular, it is possible for the influence of the transition resistances from the electrical contacts to the reducing agent to be eliminated. For this purpose, it is particularly advantageous for the electrical contacts to be arranged with different spacings to one another, such that for example the spacing between the first electrical contact and the second electrical contact is smaller than the spacing between the first electrical contact and the third electrical contact. The resistance between the first contact and the second contact can then be subtracted from the resistance between the first contact and the third contact in order to obtain a resistance for calculating the conductance.

In one advantageous embodiment of the method, in step iii), an alternating voltage, which in particular alternates between a positive voltage value and a negative voltage value, is applied to the first electrical contact and to the second electrical contact. The alternating voltage is preferably rectangular. It is furthermore preferable for the alternating voltage to be symmetrical. This means that the negative voltage component and the positive voltage component correspond in form and magnitude. By the alternating voltage, it is possible for deposits to be prevented from forming on one of the two contacts as a result of electrolysis.

The method is furthermore advantageous if, in step i), at least one of the following measures is implemented for the pretreatment of the reducing agent:
filtration of the reducing agent;
electrochemical treatment of the reducing agent;
thermal treatment of the reducing agent; and
at least partial separation of at least one component out from the reducing agent.

The described measures for the pretreatment of the reducing agent may all be performed within a line through which the reducing agent is delivered. The measures are thus implemented in each case only on a limited amount of reducing agent for which the temperature measurement and the conductivity measurement are performed in steps ii) and iii).

The filtering of the reducing agent may be performed by a filter, which may be for example a surface filter (for the deposition of particles on the filter surface) or a depth filter (for the deposition of particles in the filter).

The electrochemical treatment of the reducing agent makes it possible for certain substances to be released from and/or separated out from the reducing agent. For the electrochemical treatment, the reducing agent has applied to it an electrical voltage or an electrical current, whereby the dissolution of a component of the liquid reducing agent is effected and/or a component is separated out from the liquid reducing agent. The electrochemical treatment may also be performed by electrical contacts that are used for the conductivity measurement. For example, the electrical contacts are initially utilized (in step i)) for the pretreatment of the reducing agent and are subsequently utilized (in step iii)) in order to improve the conductivity of the reducing agent. It is in particular then the case that, for step i), use is made of electrical currents and voltages that are significantly higher than the electrical currents and voltages used in step iii).

A thermal treatment of the reducing agent is performed in particular by a heater. It is also possible for the thermal treatment to encompass cooling of the reducing agent. It is possible for certain constituents of the reducing agent to be dissolved and/or separated out by a thermal treatment. By a thermal treatment, it is also possible for the temperature of the reducing agent to be adjusted to a particular temperature value or brought into a particular temperature range in which the conductivity measurement in step iii) should take place.

The separation of a component out of the reducing agent may be performed by a separator. A separator may be for example a surface-type separator which exhibits increased adhesion for particular components of the reducing agent that are to be separated out. For example, a separator may exhibit increased adhesion for ammonia, such that ammonia is separated out from the reducing agent. A separator may also be realized by suitable flow guidance of the reducing agent in the line, such that the particles in the reducing agent are filtered out of the reducing agent for example as a result of (mass-)inertia. This particularly preferably means a purely passive separation of a component out of the reducing agent, wherein the separation is achieved exclusively by structural characteristics of the line or by suitable surface-type separators with increased adhesion for certain components, and no energy is introduced into the reducing agent for separation purposes. By contrast, in the case of the electrochemical treatment of the reducing agent, active separation is performed, wherein electrical energy is introduced into the reducing agent in order to separate at least one component out from the reducing agent.

In a further advantageous embodiment of the described method, in step iv), a plausibility check is performed in which the electrical conductivity determined in step iii) is compared with the aid of an electrical conductivity determined at an earlier point in time. Here, in particular, a deviation between the presently detected conductivity and the electrical conductivity determined at an earlier point in time, and preferably also a rate of change of the electrical conductivity, are determined. It is preferable for an error signal to be output if the deviation and/or the rate of change exceed(s) a predefined threshold value. In this case, it is assumed that a particular event has arisen which has caused the exceedance of the threshold value. For example, a tank for storing the reducing agent has been exposed to particularly high temperatures. This can cause urea-water solution, as reducing agent, to be partially converted into ammonia. Ammonia generally has a very high influence on the electrical conductivity of the reducing agent, such that an abrupt increase in electrical conductivity arises, which can be taken into consideration as a large deviation and as a high rate of change. The result of the quality measurement by the described method can in this case be discarded and, if appropriate, a corresponding error signal can be output to a control unit and/or to a user of a motor vehicle. A further event that can be identified on the basis of an exceedance of the predefined threshold value for the deviation and/or the rate of change is a misfilling event in which a liquid with a different electrical conductivity than the reducing agent is added into a tank. A misfilling event may also be identified on the basis of the deviation and/or the rate of change, and a corresponding error signal can be output to a control unit and/or to a user of a motor vehicle.

The concentration of urea-water solution taken into consideration during the quality measurement may vary in the tank substantially owing to two influences. The first influence is the formation of ammonia in the tank, as already described further above. The second influence is the formation of (crystalline) deposits of urea. The urea contained in such deposits is separated out from the urea-water solution and accordingly reduces the urea concentration. Whereas the first influence has a short-term and very rapid effect and thus results in abrupt changes in electrical conductivity, the second influence is relatively slow, and can therefore be monitored in a highly effective manner during the quality measurement by the described method.

According to a further aspect of the invention, there is proposed a dosing device for a reducing agent, having a tank with a tank wall and with an interior that is at least partially delimited by the tank wall, having a sensor for determining the electrical conductivity of the reducing agent, and having at least one line via which reducing agent is extracted from the interior. The at least one line is connected in terms of flow to the interior such that the reducing agent can be conducted from the interior into an exhaust line, wherein the sensor is arranged on the line, and a pretreatment unit for the pretreatment of the reducing agent is also arranged on the line.

The dosing device thus comprises a tank, which stores the reducing agent, and at least one line that leads from the tank to an exhaust line. The dosing device preferably additionally has a delivery device which, in particular, has a pump that delivers the reducing agent out of the tank via the at least one line. In particular, the sensor for determining the conductivity of the reducing agent is specifically arranged not in the interior of the tank but rather in the line, such that the quality of the reducing agent that is to be delivered (immediately thereafter) into the exhaust line is determined. That section of the line on which the sensor is arranged may also be a constituent part of the delivery device: This has the advantage that the quality of the reducing agent that is actually dosed is determined, rather than the quality of the reducing agent in the tank, because the quality of the reducing agent could vary locally in the tank. Furthermore, upstream of the sensor as viewed in the flow direction, there is arranged at least one pretreatment unit by which the reducing agent can be pretreated in preparation for the quality measurement. The pretreatment unit is preferably arranged upstream of and/or at the sensor as viewed in the flow direction for the reducing agent from the tank to the exhaust line.

It is particularly preferable for the sensor to have a first electrical contact and a second electrical contact electrically connected to the reducing agent in the line.

The first electrical contact and the second electrical contact are thus in particular arranged in the dosing device such that, during operation, an electrical resistance of the reducing agent can be determined between the first electrical contact and the second electrical contact downstream of the pretreatment unit, in the delivery device or in the at least one line. For this purpose, the electrical contacts are preferably guided through the housing or through the casing of the delivery device and/or of the line in electrically insulated fashion. It is thus possible in particular for regions of the dosing device that are not situated in the continuous, non-divided interior of the tank, in which the reducing agent is stored, to be regarded as belonging to the delivery device and/or to the at least one line.

Where “electrical contacts” are referred to here, this means the first electrical contact and the second electrical contact, wherein this terminology is not intended to express that the first electrical contact and the second electrical contact must then always be of identical design; in fact, this is intended to express that at least one of the contacts may be designed in this way.

The electrical contacts that together form the sensor are preferably cast into the housing of the delivery device or into the line. It is additionally possible if appropriate for at least one sealing element to be jointly cast into the housing, which sealing element seals off the electrical contacts with respect to the housing. The electrical contacts are preferably in the form of metallic pins. The metallic pins may if appropriate have a surface structure that promotes the formation of the housing wall or of the line at the metallic pins. It is also possible, if appropriate, for a groove to be formed into the metallic pins, into which groove engages a sealing element—such as for example an O-ring seal.

Here, on the one hand, it is possible for the electrical contacts to extend in each case individually through the housing of the delivery device or through the casing of the line. It is however possible for the metallic pins that form the electrical contacts to be arranged in a common sealing element and for the sealing element as a whole to be embedded into the housing or extend through the housing.

By such an embodiment of the dosing device, it is ensured that the quality of reducing agent that is to be delivered (immediately thereafter) into the exhaust line, and which is thus no longer exposed to the influences of, for example, impurities present in the interior, can be determined.

The electrical contact of the sensor is preferably guided through a housing of the delivery device or through a wall of the line, such that no reducing agent or additive of the reducing agent can penetrate out of the dosing device through said leadthrough.

It is particularly preferable if at least the first electrical contact or the second electrical contact is sealed off in liquid-tight fashion on the line by a capillary barrier, wherein the capillary barrier is formed by a cohesive connection between firstly the first electrical contact or the second electrical contact and secondly at least one fastening section of the line.

A capillary barrier of this type is formed in particular by a cohesive connection between at least one electrical contact and a fastening section. The fastening section refers in particular to a housing of the delivery device and/or a wall of the line. Furthermore, however, the fastening section may also comprise a seal region which is arranged in one of the above-mentioned housings or walls. A cohesive connection of this type may be realized by welding, brazing or adhesive bonding.

A cohesive connection is in particular a connection at a molecular level, in which molecular forces exist between the electrical contacts and the material of the line. The electrical contacts are preferably composed of a metallic material, whereas the line is formed from a plastics material. The cohesive connection is then formed either by an adhesive, which can enter into a cohesive connection both with the metallic material of the electrical contacts and with the plastics material, or the plastics material of the line and the metallic material of the electrical contacts are selected such that a direct cohesive connection can be formed between the plastics material and the metallic material. This is possible for example with the metallic materials high-grade steel, copper or aluminum and with the plastics polyoxymethylene (POM), polyamide (PA), in particular PA 6.6 (Nylon), polyphthalamide (PPA) or polyphenylene sulphide (PPS).

In a further design variant, the electrodes are composed of an electrically conductive plastic. A plastic of this type may be made conductive by suitable (preferably metallic) inserts. It is also possible for a plastic of this type to be inherently conductive. A conductive plastic is for example polypyrrole (PPy).

It is furthermore preferable if at least the first electrical contact or the second electrical contact is sealed off in liquid-tight fashion on the line by a capillary barrier, wherein the capillary barrier is realized by a form fit between firstly the first electrical contact or the second electrical contact and secondly at least one fastening section of the line.

Such a form fit may for example be formed by a labyrinth seal between the tank wall, the housing of a delivery device and/or the wall of a line. In the case of a labyrinth seal, the electrical contact has a protuberance by which improved sealing of the pins in the housing is attained. It is particularly preferable for the electrical contact to have a multiplicity of protuberances in the region in which it is guided through the fastening section.

It is also considered to be advantageous for the sensor and the dosing device to have a common housing. A housing of this type is in particular of one-piece form. A one-piece housing may be produced by virtue of a U-shaped electrical contact being inlaid during the injection molding of the housing, and the connecting section of the straight legs of the U-shaped contact being removed after the production process. The sensor may however furthermore also share a common, in particular one-piece housing with the tank and/or the delivery device. In this way, a sensor can be integrated into a dosing device in a simple manner.

In a further preferred design variant of the dosing device, at least the first electrical contact or the second electrical contact has a corrosion prevention structure. A corrosion prevention structure of this type may be realized for example by a corresponding coating of the electrical contacts. A coating of the electrical contacts with the following materials is particularly preferable. Electrodes formed from aluminum may for example be provided with an aluminum oxide-polymer composite coating formed by conversion of the aluminum at the surface, wherein aluminum oxide is formed and bonds with at least one polymer material. Such aluminum oxide-polymer composite coatings may be applied to the electrodes for example by the CompCote® method, and are distinguished in particular by a high level of corrosion resistance.

The corrosion prevention structure may alternatively be realized by the attachment of a sacrificial anode. A sacrificial anode is realized by coating the electrical contacts with a less noble material than that of the electrical contact. The service life of the electrical contacts is lengthened by a corrosion prevention means.

It is also considered to be advantageous for the sensor to have a third electrical contact.

By a third electrical contact, the conductance of the reducing agent can be determined over at least two distances, such that the determination of the conductance can be performed with greater accuracy. In particular, it is possible in this embodiment for at least two of the three electrodes to be composed of a different material. The spacings between the individual electrical contacts preferably differ. For example, it is preferable for the first electrical contact and the second electrical contact to have a first spacing to one another, and for the first electrical contact and the third electrical contact to have a second spacing to one another, wherein the first spacing is smaller than the second spacing. It is then possible to perform a difference measurement with the aid of the (three) electrical contacts. By a difference measurement, it is possible for the conductance of the reducing agent to be determined even if corrosion occurs on the electrical contacts because, by a difference measurement, a transition resistance of the corrosion on the electrical contacts is canceled out. It is however a requirement for this that the corrosion on the electrical contacts is uniform. It is also considered to be advantageous for the dosing device to comprise a temperature sensor.

The temperature sensor is preferably formed in the direct vicinity of the sensor, such that the temperature of the reducing agent can be determined in the vicinity of the sensor. The temperature sensor is preferably arranged with a second spacing of at most 10 cm to the sensor.

It is also provided that the temperature sensor is attached to an electrical contact. The temperature sensor is preferably attached to the electrical contact outside the delivery device or the line. Electrically conductive contacts generally also have good thermal conductivity owing to their inherent electrical conductivity. The electrical contact thus constitutes a thermal bridge through the housing of the delivery device or through the line. This can be utilized in order to determine the temperature, ascertained via one of the two electrical contacts, in the interior of the delivery device or in the interior of the line.

In one advantageous embodiment of the dosing device, the first contact and the second contact have a first spacing of at most 5 cm, preferably of at most 2 cm, to one another. With such a relatively low first spacing, it is ensured that the measurement of the conductance is not dependent on other influences. Here, the first spacing is determined in particular along the current path between the two contacts.

According to yet a further embodiment of the dosing device, the contacts are formed from graphite, high-grade steel or platinum.

In this context, it is preferable for more than one sensor to be provided, wherein the electrical contacts of the various sensors are formed with contacts composed of different materials. It is accordingly preferable in particular for one sensor to have electrical contacts composed of graphite and for the other sensor to have electrical contacts composed of high-grade steel or platinum. Through the use of different materials for the various sensors, the accuracy of the determined conductance can be increased by virtue of the conductances determined by the two sensors being averaged or by virtue of only the conductance of one sensor being taken into consideration, wherein the sensor that is taken into consideration depends on the order of magnitude of the determined conductances. It is thus possible for the quality of the reducing agent to be determined with greater accuracy.

It is particularly advantageous for the pretreatment unit to comprise at least one of the following components:
at least one filter that purifies the reducing agent flowing through the line;
at least one electrical contact, wherein the at least one electrical contact is configured to perform an electrochemical treatment of the reducing agent;
at least one heater for the thermal treatment of the reducing agent; and
at least one separator by which at least one component can be at least partially separated out from the reducing agent.

With a filter, it is possible for a reducing agent to be filtered for pretreatment purposes. The filter may in particular be a surface-type filter by which (solid) constituents can be separated out from the reducing agent on the surface of the filter. A surface-type filter is, for example, a screen by which particles larger than a certain size in the reducing agent can be retained.

The possibilities of performing electrochemical treatment of the reducing agent by at least one electrical contact have already been explained further above. The at least one electrical contact may have the same features as the electrical contacts of the sensor for conductivity measurement. It is particularly preferable for at least two electrical contacts to be provided which are used both as a pretreatment unit and as a sensor for conductivity measurement.

The possibilities of treating the reducing agent by a heater have likewise already been described further above. A heater may in particular comprise a PTC heating element configured such that the reducing agent in the line is adjusted to a uniform (constant) temperature. It is also possible for a cooler to be provided in addition to the heater, by which cooler the temperature of the reducing agent can be reduced if required.

A separator for separating out a component is preferably a surface-type separator on which certain components of the reducing agent can accumulate owing to adhesion. Alternatively, a separator may also be realized by a region of the line with at least one flow diversion, wherein components of the reducing agent can be separated out owing to the flow diversion.

In a further embodiment of the dosing device, the dosing device is connected to a controller equipped and configured to operate the dosing device in accordance with the method according to the invention. In particular, the controller is connected to the sensor and to a temperature sensor and can determine and display the quality of the reducing agent. The advantages and design features specified for the described method can be transferred analogously to the dosing device. The same applies to the advantages and design features specified for the described dosing device, which can be transferred to the described method.

The invention is particularly preferably used in a motor vehicle having an internal combustion engine with an exhaust-gas treatment device which has an exhaust line and which has a dosing device according to the invention.

### BRIEF DESCRIPTION OF THE DRAWINGS

The invention and the technical field will be explained in more detail below on the basis of the figures. The figures show particularly preferred exemplary embodiments, to which the invention is however not restricted. In particular, it should be noted that the figures and in particular the illustrated proportions are merely schematic. In the figures:

FIG. 1: shows a motor vehicle having a dosing device;

FIG. 2: shows a first design variant of a dosing device;

FIG. 3: shows a second design variant of a dosing device;

FIG. 4: shows a third design variant of a dosing device;

FIG. 5: shows a line of a dosing device;

FIG. 6: shows a further line of a dosing device;

FIG. 7: shows a fastening section of a dosing device; and

FIG. 8: shows a plan view of a fastening section of a dosing device.

### DETAILED DESCRIPTION OF THE PRESENTLY PREFERRED EMBODIMENTS

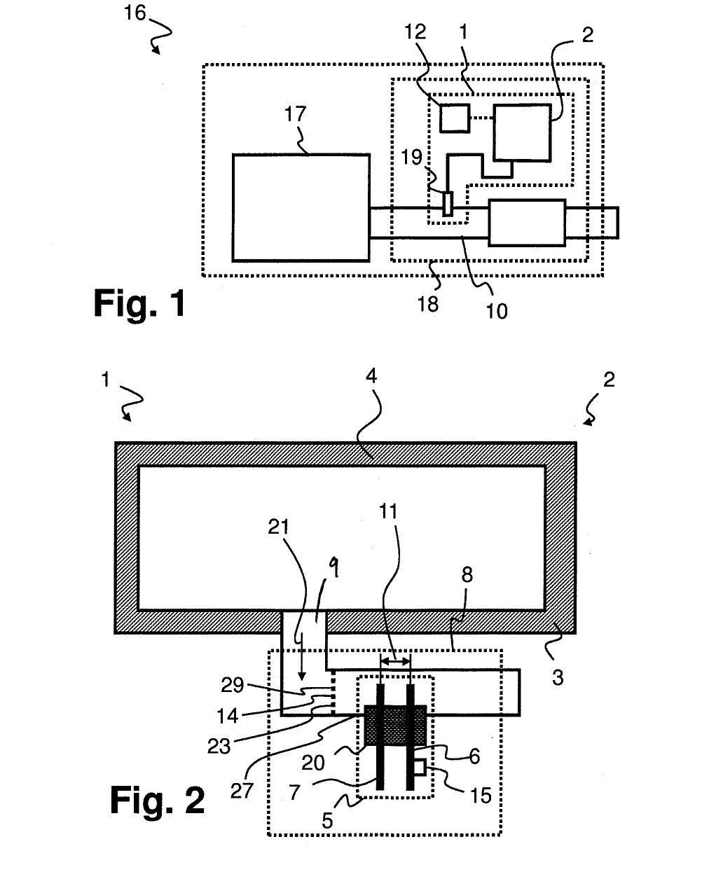

FIG. 1 schematically shows a motor vehicle 16 having an internal combustion engine 17 and having an exhaust-gas treatment device 18 with an exhaust line 10. A dosing device 1 is provided on the exhaust-gas treatment device 18. The dosing device has a tank 2, a delivery device 8 (FIG. 2) and an injector 19. As can be seen in FIG. 2, the tank 2 has an interior 4 which is delimited by a tank wall 3. Liquid reducing agent stored in the tank 2 can, by the delivery device 8, be delivered to the injector 19 and injected into the exhaust line 10 in predefined amounts. The dosing device 1 furthermore comprises a controller 12 that controls the dosing device 1.

FIG. 2 illustrates a dosing device 1. The dosing device 1 has a tank 2. A line 9 on which a sensor 5 is arranged extends from the tank. The sensor 5 has a first electrical contact 6 and a second electrical contact 7. The first electrical contact 6 and the second electrical contact 7 are arranged with a spacing 11 to one another and are led through a fastening section 27 of the tank 2 with a seal 20. A temperature sensor 15 is fastened to the first contact 6, by which temperature sensor the temperature in the line 9 or the temperature of the reducing agent in the line 9 can be detected. Furthermore, a pretreatment unit 29 is provided on the line 9 upstream of the sensor 5 as viewed in the flow direction 21 from the tank 2 to the exhaust line 10, by which pretreatment unit the reducing agent can be pretreated, wherein the pretreatment unit is a filter 14, in the case of which particles are deposited on a surface and which can therefore be referred to as a surface-type filter 23. A typical example of a surface-type filter 23 is a screen.

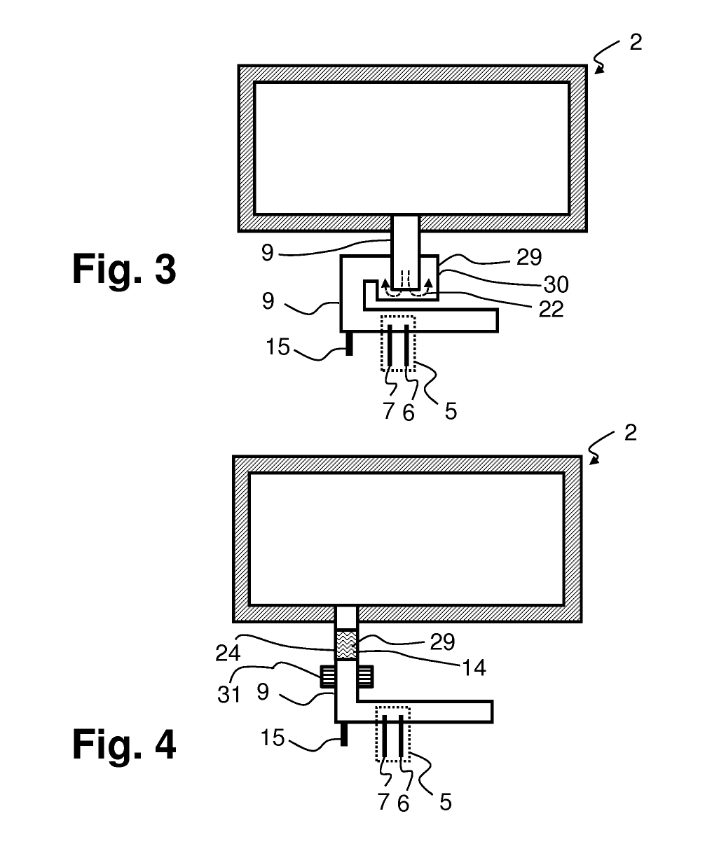

FIG. 3 shows a further dosing device 1 with a sensor 5 on a line 9 outside the tank 2, which sensor is formed with a first electrical contact 6 and a second electrical contact 7. Here, as a pretreatment unit 29, a separator 30 is provided which is formed with a flow diversion 22 for diverting the flow of the reducing agent in the line 9.

FIG. 4 shows a further exemplary embodiment of a dosing device 1 with a sensor, which corresponds to the exemplary embodiment from FIG. 3. Here, as a pretreatment unit 29, a filter 14 is provided, in the case of which impurities are separated out within the filter. The filter 14 may therefore be referred to as a depth filter 24. A heater 31 for the pretreatment of the reducing agent is additionally arranged on the line 9.

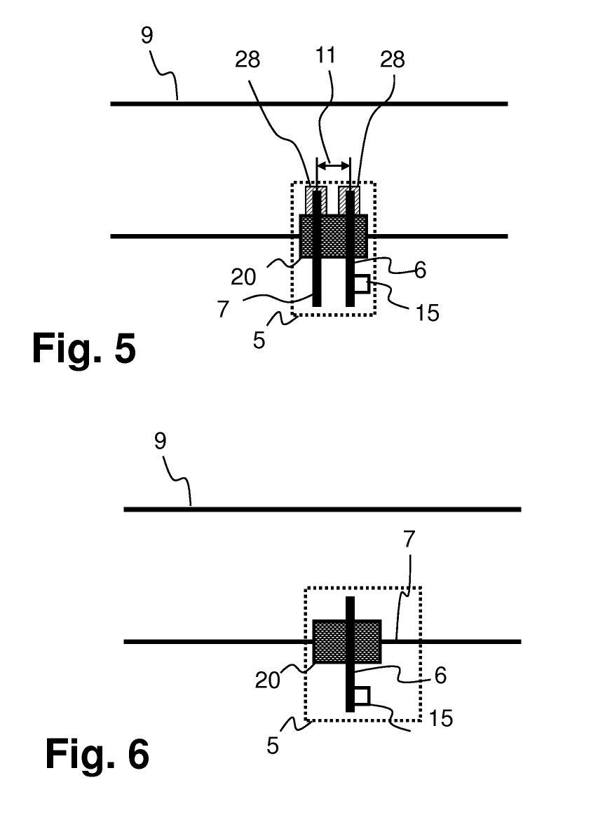

FIG. 5 illustrates a line 9 through which liquid reducing agent is delivered. A sensor 5, with a first electrical contact 6 and a second electrical contact 7, is integrated in the line 9. The electrical contacts 6, 7 are guided through the wall of the line 9 into the interior of the line 9 with a seal 20. The first electrical contact 6 and the second electrical contact 7 are arranged with a spacing 11 to one another in order that the electrical resistance of reducing agent can be determined between them. On the outside, a temperature sensor 15 is attached to the first electrical contact 6, which temperature sensor makes it possible to determine the temperature of the reducing agent in the line 9. Furthermore, the electrical contacts 6, 7 each have a corrosion prevention structure 28. The corrosion prevention structure 28 is realized by a sacrificial anode formed by a less noble metal than the material of the electrical contacts.

FIG. 6 illustrates a further embodiment of the line 9. Here, the sensor 5 is formed by an electrical pin as first electrical contact 6 and by the wall of the line 9 as second electrical contact 7. The first electrical contact 6 is introduced into the interior of the line 9 in electrically insulated fashion through the seal 20. The electrical resistance between the electrical pin as first electrical contact 6 and the wall of the line 9 as second electrical contact 7 can be determined. To the first electrical contact 6 there is furthermore attached a temperature sensor 15 for determining the temperature of the liquid reducing agent.

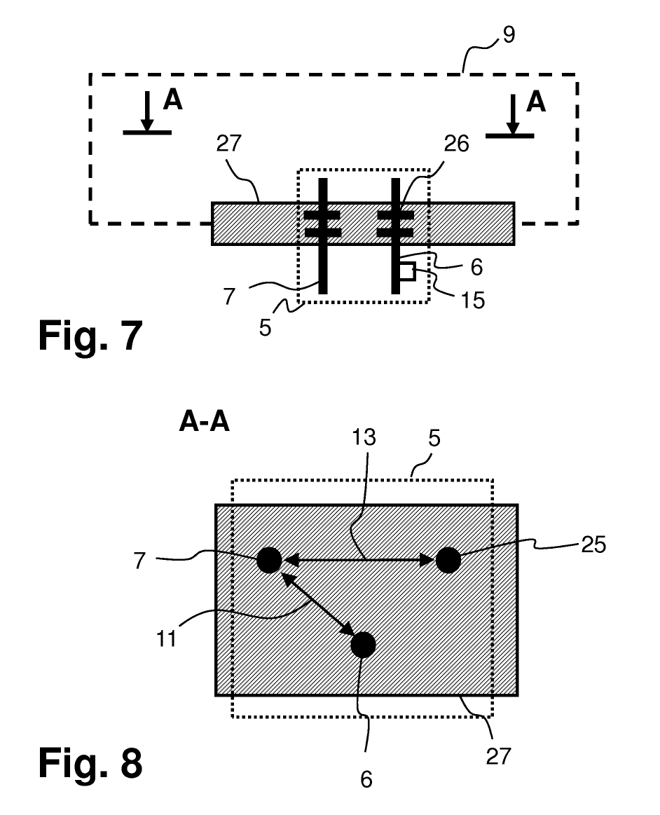

FIG. 7 shows a fastening section 27 with a sensor 5. The fastening section may be the tank wall 3, the housing of the delivery device 8, the wall of the line 9, and if appropriate also the seal 20. The sensor 5 comprises a first electrical contact 6, to which a temperature sensor 15 is attached, and a second electrical contact 7. The first electrical contact 6 and the second electrical contact 7 are fastened in the fastening section 27 by a capillary barrier 26. Here, the capillary barrier 26 is realized by a labyrinth seal that generates a form fit between the fastening section 27 and the electrical contacts 6, 7.

FIG. 8 illustrates a plan view of a fastening section 27 of FIG. 7, wherein FIG. 8 shows the view of the fastening section 27 as denoted by the arrows A in FIG. 7. The fastening section may be the tank wall 3, the housing of the delivery device 8, the wall of the line 9, and if appropriate also the seal 20. A sensor 5 with a first electrical contact 6, a second electrical contact 7 and a third electrical contact 25 is integrated in the fastening section 27. An electrical voltage can be applied in each case between two of the three electrical contacts 6, 7, 25, such that an electrical resistance can be measured over up to three distances through the reducing agent. The electrical contacts 6, 7, 25 are arranged with different spacings to one another. A spacing 11 exists between the first electrical contact 6 and the second electrical contact 7, whereas the first electrical contact 6 and the third electrical contact 25 have a reference spacing 13 to one another. From the up to three resulting electrical resistances, the conductance of the reducing agent can be determined in a very accurate manner.

By the present invention, it is possible to determine the quality of the reducing agent, which makes it possible for the amount of reducing agent to be delivered to be adapted to the quality of the reducing agent, such that less reducing agent is consumed, or sufficient urea is delivered into the exhaust line, as appropriate in the respective situation.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

### LIST OF REFERENCE NUMERALS

1 Dosing device
2 Tank
3 Tank wall
4 Interior
5 Sensor
6 First contact
7 Second contact
8 Delivery device
9 Line
10 Exhaust line
11 Spacing
12 Controller
13 Reference spacing
14 Filter
15 Temperature sensor
16 Motor vehicle
17 Internal combustion engine
18 Exhaust-gas treatment device
19 Injector
20 Seal
21 Flow direction
22 Flow diversion
23 Surface-type filter
24 Depth filter
25 Third contact
26 Capillary barrier
27 Fastening section
28 Corrosion prevention means
29 Pretreatment unit
30 Separator
31 Heater

1-14. (canceled)

15. A method for determining a quality of reducing agent, comprising at least the following steps:
i) performing a pretreatment of the reducing agent;
ii) determining a temperature of the pretreated reducing agent;
iii) determining an electrical conductivity of the pretreated reducing agent; and
iv) calculating a quality of the reducing agent based on the determined electrical conductivity and the determined temperature.

16. The method according to claim 15, wherein the determination of the electrical conductivity of the reducing agent in step iii) is performed by means of a sensor (5) with a first electrical contact (6) and a second electrical contact (7) which are electrically connected to the reducing agent.

17. The method according to claim 16, wherein, in step iii), a voltage is applied in each case between at least the first electrical contact (6) and the second electrical contact (7) and between the first electrical contact (6) and a third electrical contact (25), wherein electrical resistances between the first electrical contact (6) and the second electrical contact (7) and between the first electrical contact (6) and the third electrical contact (25) are determined and, in step c), a conductance is determined from the two determined electrical resistances.

18. The method according to claim 16, wherein, in step iii), an alternating voltage is applied.

19. The method according to claim 15, wherein, in step i), at least one selected from the group consisting of the following measures is implemented for the pretreatment of the reducing agent:
filtration of the reducing agent;
electrochemical treatment of the reducing agent;
thermal treatment of the reducing agent; and
at least partial separation of at least one component out from the reducing agent.

20. A dosing device (1) for a reducing agent, comprising:
a tank (2) having a tank wall (3) and an interior (4) at least partially delimited by the tank wall (3);
a sensor (5) configured to determine electrical conductivity of the reducing agent;
an exhaust line (10);
a pretreatment unit (29) configured to pretreat the reducing agent; and
at least one line (9) via which the reducing agent is extracted from the interior (4), the at least one line (9) being connected in terms of flow to the interior (4) such that the reducing agent can be conducted from the interior (4) through the line (9) into the exhaust line (10),
wherein both the sensor (5) and the pretreatment unit (29) are arranged on the line (9).

21. The dosing device (1) according to claim 20, wherein the sensor (5) has a first electrical contact (6) and a second electrical contact (7) each of which are electrically connected to the reducing agent.

22. The dosing device (1) according to claim 21, further comprising a capillary barrier (26) formed by a cohesive connection between firstly at least the first electrical contact (6) or the second electrical contact (7) and secondly at least one fastening section (27) of the line (9),
wherein at least one selected from the group consisting of the first electrical contact (6) and the second electrical contact (7) is sealed off in liquid-tight fashion on the line (9) by the capillary barrier (26).

23. The dosing device (1) according to claim 21, further comprising a capillary barrier (26) realized by a form fit between firstly at least the first electrical contact (6) or the second electrical contact (7) and secondly at least one fastening section (27) of the line (9),
wherein at least one selected from the group consisting of the first electrical contact (6) and the second electrical contact (7) is sealed off in liquid-tight fashion on the line (9) by the capillary barrier (26).

24. The dosing device (1) according to claim 20, wherein the sensor (5) has a third electrical contact (25).

25. The dosing device (1) according to claim 20, further comprising a temperature sensor (15).

26. The dosing device according to claim 21, wherein the first and second electrical contacts (6, 7) are formed from at least one selected from the group consisting of the following materials:
graphite,
high-grade steel, and
platinum.

27. The dosing device (1) according to claim 20, wherein the pretreatment unit (29) comprises at least one selected from the group consisting of the following components:
at least one filter (14) configured to purify the reducing agent flowing through the line (9);
at least one electrical contact (6, 7, 25), wherein the at least one electrical contact (6, 7, 25) is configured to perform an electrochemical treatment of the reducing agent;
at least one heater (31) configured to thermally treat the reducing agent; and
at least one separator (30) by which at least one component can be at least partially separated out from the reducing agent.

28. A motor vehicle (16), comprising:
an internal combustion engine (17);
an exhaust-gas treatment device (18);
an exhaust line (10); and
a dosing device (1) according to claim 20.
